(19) United States
(12) Patent Application Publication
(10) Pub. No.: US 2022/0141352 A1
(43) Pub. Date: May 5, 2022

(54) IMAGE DATA TRANSMISSION APPARATUS AND IMAGE DATA TRANSMISSION METHOD

(71) Applicant: SHARP KABUSHIKI KAISHA, Sakai City (JP)

(72) Inventor: Hitoshi MITSUI, Sakai City (JP)

(21) Appl. No.: 17/513,742

(22) Filed: Oct. 28, 2021

(30) Foreign Application Priority Data
Oct. 29, 2020 (JP) 2020-181622

(51) Int. Cl. H04N 1/44; H04N 1/00

(52) U.S. Cl. CPC H04N 1/4406; G06F 21/31; H04N 1/00411; H04N 1/00477

(57) ABSTRACT

An image data transmission apparatus that includes an operator that receives an command from a user, a transmission status generator that generates a dedicated page to check a transmission status of image data, a display that displays various kinds of screens, and a controller that controls the operator, the transmission status generator, and the display, in which when the operator receives a command to transmit the image data, the controller causes the transmission status generator to generate the dedicated page to check the transmission status of the image data, and causes the display to display a transmission screen including address information that enables access to the dedicated page, and a transmit start button to start transmission of the image data.

### BACKGROUND OF THE INVENTION

### Field of the Invention

The present invention relates to an image data transmission apparatus and an image data transmission method, and more particularly, to an image data transmission apparatus having an image data transmission function for transmitting image data by email, facsimile, or the like, and an image data transmission method.

### Description of the Background Art

Conventional image forming apparatuses, such as multifunction peripherals (MFPs), are known to have a history function that displays the status of image forming jobs, such as printing and scanning, and allows reuse of image data having been transmitted before.

In the MFPs having such a history function, if the image data transmission apparatus is used with an invalid user authentication, a third party other than the user can refer to the past job history as well as acquiring the image data pertaining to the job.

In connection with such a problem, a data communication device, in which transmission histories of many users have conventionally been registered in a mixed manner, can display a communication history by converting and hiding part of information of the communication history which is important or desired to be kept secret for each user into an unreadable format by a non-reading means for making such information from being read by a third party (see, for example, Japanese Unexamined Patent Application Publication No. 2010-273030).

However, in the conventional method, each user had to register an identification (ID) number and a password in advance in order to use encryption of the transmission history.

In addition, in a case where an image data transmission apparatus installed in a public space such as a convenience store, a shared office, or a rental conference room used by an unspecified number of users, it is not practically possible to require all users to undergo user authentication or user registration.

The present invention has been made in view of the above circumstances, and provides an image data transmission apparatus and an image data transmission method in which only a user who has executed a transmission job can refer to its transmission status, even when the user executes the transmission job without user authentication or registration.

### SUMMARY OF THE INVENTION

(1) An image data transmission apparatus according to an aspect of the present invention includes an operator that receives a command from a user, a transmission status generator that generates a dedicated page to check a transmission status of image data, a display that displays various kinds of screens, and a controller that controls the operator, the transmission status generator, and the display, in which, when the operator receives a command to transmit the image data, the controller causes the transmission status generator to generate the dedicated page to check the transmission status of the image data, and causes the display to display a transmission screen including address information that enables access to the dedicated page, and a transmit start button to start transmission of the image data.

An image data transmission apparatus according to an aspect of the present invention includes an operator that receives a command from a user, a transmission status generator that generates a dedicated page to check a transmission status of image data, a display that displays various types of screens, and a controller that controls the operator, the transmission status generator, and the display, in which, when the operator receives a command to transmit the image data, the controller causes the transmission status generator to generate the dedicated page to check the transmission status of the image data, and causes the display to display a registration screen including an authentication information entry form to register authentication information to access the dedicated page.

An image data transmission method according to an aspect of the present invention includes operating to receive a command from a user, generating a transmission status to generate a dedicated page to check a transmission status of image data, and displaying various kinds of screens, in which, when a command to transmit the image data is received in the operating, the dedicated page to check the transmission status of the image data is generated in the generating of the transmission status, and the display is caused, in the displaying, to display a transmission screen including address information that enables access to the dedicated page, and a transmit start button to start transmission of the image data.

An image data transmission method according to an aspect of the present invention includes operating to receive an command from a user, generating a transmission status of image data to generate a dedicated page to check a transmission status, and displaying various types of screens, in which, when a command to transmit the image data is received in the operating, the dedicated page to check the transmission status of the image data is generated in the generating of the transmission status, and in the displaying, a registration screen including an authentication information entry form for registering authentication information to allow access to the dedicated page is displayed.

According to an aspect of the present invention, the “image data transmission apparatus” is an apparatus having a function such an email function for transmitting data of a file containing an image or the like to an external device.

According to an aspect of the present invention, the image data transmission apparatus and the image data transmission method in which only the user who has executed a transmission job can refer to the transmission status, even when the user executes the transmission job without user authentication or registration, is provided.

Furthermore, preferred modes of the present invention are described below.

(2) When the operator receives a command to start transmission of the image data, the controller may hide the address information on the display.

In this way, the address information is hidden on the display when the command to start transmission of the image data is received from the user. Thus, the image data transmission apparatus in which only the user who has executed the transmission job can refer to the transmission status, even when the user has executed the transmission job without user authentication or registration, is provided.

(3) The controller may cause the display to display the transmission screen in a code format allowing a mobile terminal to read the address information that enables access to the dedicated page.

In this way, the transmission status can be accessed by reading the code displayed on the transmission screen with the mobile terminal. Thus, the image data transmission apparatus in which only the user who has executed a transmission job can refer to the transmission status, even when the user executes the transmission job without user authentication or registration, is provided.

The “code format that can be read by the mobile terminal” includes, for example, a quick response (QR) code (registered trademark).

(4) The controller may cause the display to display the transmission screen including an authentication information entry form for setting authentication information to allow access to the dedicated page.

In this way, the authentication information to allow access the dedicated page is set. Thus, the image data transmission apparatus in which only the user who has executed a transmission job can refer to the transmission status, even when the user executes the transmission job without user authentication or registration, is provided.

“The authentication information to allow access the dedicated page” is, for example, a keyword or login name and password set by the user on an ad hoc basis.

(5) The controller may cause the transmission status generator to generate the dedicated page on which at least one of a button for retransmitting the image data, a button for changing a destination address of the image data for transmission, and a button for deleting the image data is displayed.

In this way, the image data transmission apparatus in which only the user who has executed the transmission job can refer to the transmission status and which allows at least one of retransmission of the transmitted image data, change of the destination address of the image data for transmission, and deletion of the image data, even when the user executes the transmission job without user authentication or registration, is provided.

(6) According to the image data transmission apparatus according to an aspect of the present invention, when the operator accepts registration of the authentication information, the controller causes the display to display address information that enables access to the dedicated page.

In this way, when the registration of the authentication information from the user is accepted, the address information is hidden on the display. Thus, the image data transmission apparatus in which only the user who has executed the transmission job can refer to the transmission status, even when the user has executed the transmission job without user authentication or registration, is provided.

(7) According to the image data transmission apparatus according to an aspect of the present invention, when a predetermined amount of time has passed after the controller causes the display to display the address information, the controller may hide the address information on the display.

In this way, when the predetermined amount of time has passed, the controller hides the address information on the display. Thus, the image data transmission apparatus in which only the user who has executed the transmission job can refer to the transmission status of the image data, even when the user has executed the transmission job without user authentication or registration, is provided.

### BRIEF DESCRIPTION OF THE DRAWINGS

FIG. 1 is an explanatory view of an example of an image forming system according to a first embodiment of the present invention;

FIG. 2 is a plan view of a digital multifunction printer of FIG. 1;

FIG. 3 is an explanatory view of an operation panel of the digital multifunction printer of FIG. 1;

FIG. 4 is a block diagram schematically illustrating a configuration of the digital multifunction printer of FIG. 1;

FIG. 5 is a block diagram schematically illustrating a configuration of the mobile terminal of FIG. 1;

FIG. 6 illustrates an example of a scan mode screen of the digital multifunction printer of FIG. 1;

FIG. 7 is a flowchart illustrating a job execution process flow of the digital multifunction printer of FIG. 1;

FIG. 8 is an example of a job status transmission dialog of the digital multifunction printer of FIG. 1;

FIG. 9 is a flowchart illustrating an access flow to a dedicated page illustrating the job transmission status of the digital multifunction printer of FIG. 1;

FIG. 10 is an example of a screen of the mobile terminal on which a job status screen of the digital multifunction printer of FIG. 1 is displayed;

FIG. 11 is a flowchart illustrating a job execution process flow of a digital multifunction printer according to a second embodiment of the present invention;

FIG. 12 is an example of a job status transmission dialog of the digital multifunction printer according to the second embodiment of the present invention;

FIG. 13 is a flowchart illustrating an access flow to a dedicated page illustrating a job transmission status of the digital multifunction printer according to the second embodiment of the present invention;

FIG. 14 is an example of a keyword entry screen displayed after the mobile terminal reads the QR code of the job status transmission dialog of the digital multifunction printer according to the second embodiment of the present invention;

FIG. 15 is an example of a keyword entry error screen of the mobile terminal that accesses a job status screen of the digital multifunction printer according to the second embodiment of the present invention;

FIG. 16 is a flowchart illustrating a job execution process flow of the digital multifunction printer according to a third embodiment of the present invention;

FIG. 17 is an example of a job status transmission dialog of a digital multifunction printer according to the third embodiment of the present invention;

FIG. 18 is an example of a dialog illustrating a method of accessing a unique resource locator (URL) of a dedicated page for a job of the digital multifunction printer according to the third embodiment of the present invention;

FIG. 19 is a flowchart illustrating an access flow to a dedicated page illustrating a job transmission status of the digital multifunction printer according to the third embodiment of the present invention;

FIG. 20 is an example of a login name and password entry screen displayed after the mobile terminal reads a QR code of the job status transmission dialog of the digital multifunction printer according to the third embodiment of the present invention;

FIG. 21 is an example of a login name and password entry error screen of the mobile terminal that accesses the job status screen of the digital multifunction printer according to the third embodiment of the present invention;

FIG. 22 is a flowchart illustrating a job execution process flow of a digital multifunction printer according to a fourth embodiment of the present invention;

FIG. 23 is an example of a login name and password registration dialog of the digital multifunction printer according to the fourth embodiment of the present invention;

FIG. 24 is an example of a dialog illustrating a method of accessing a URL of a dedicated page for a job of the digital multifunction printer according to the fourth embodiment of the present invention;

FIG. 25 is a flowchart illustrating an access flow to the dedicated page illustrating a job transmission status of the digital multifunction printer according to the fourth embodiment of the present invention;

FIG. 26 is an example of a login name and password entry screen displayed after the mobile terminal reads the QR code of the job status transmission dialog of the digital multifunction printer according to the fourth embodiment of the present invention;

FIG. 27 is an example of a login name and password entry error screen of the mobile terminal that accesses the job status screen of the digital multifunction printer according to the fourth embodiment of the present invention;

FIG. 28 is an example of a screen of the mobile terminal during job transmission on the job status screen of the digital multifunction printer according to the fourth embodiment of the present invention is displayed; and

FIG. 29 s an example of a screen of the mobile terminal on which the job status screen of the digital multifunction printer according to the fourth embodiment of the present invention is displayed.

### DESCRIPTION OF THE PREFERRED EMBODIMENTS

The present invention will be described in detail with reference to the accompanying drawings. The following description is given merely for describing examples in all respects, and shall not be construed as limiting the present invention.

### First Embodiment

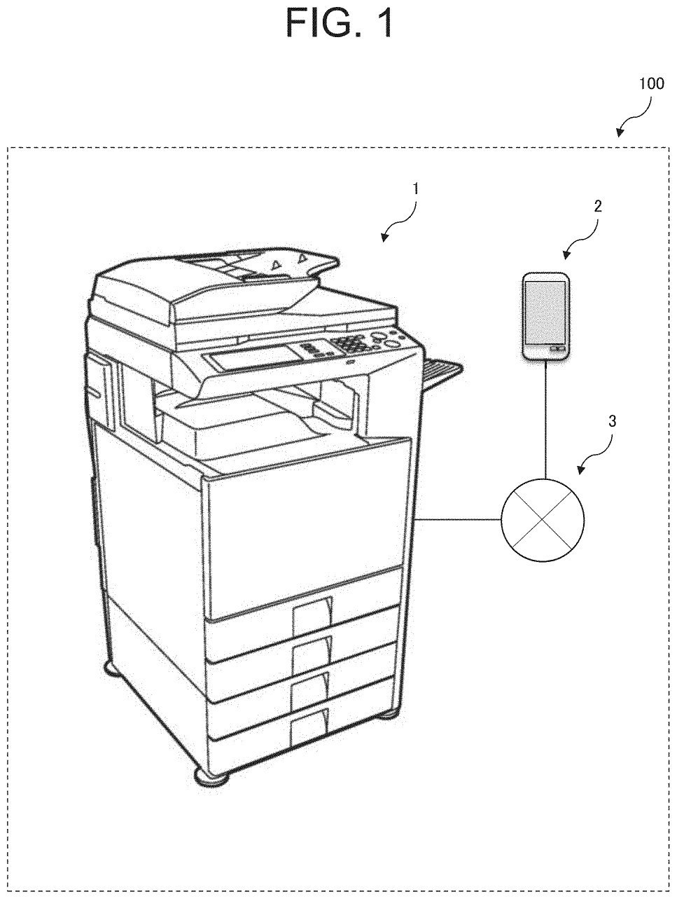

By referring to FIGS. 1 to 5, an image forming system 100 including a digital multifunction printer 1, which is an embodiment of an image data transmission apparatus of the present invention, is described.

FIG. 1 is an explanatory view of an example of the image forming system 100 according to a first embodiment of the present invention.

As illustrated in FIG. 1, the image forming system 100 includes the digital multifunction printer 1, a mobile terminal 2, and a network 3.

The digital multifunction printer 1 in accordance with the first embodiment of the present invention is an apparatus such as a multifunction printer or an MFP that digitally processes image data, having a copy function, a printer function, a scanner function, and a facsimile function.

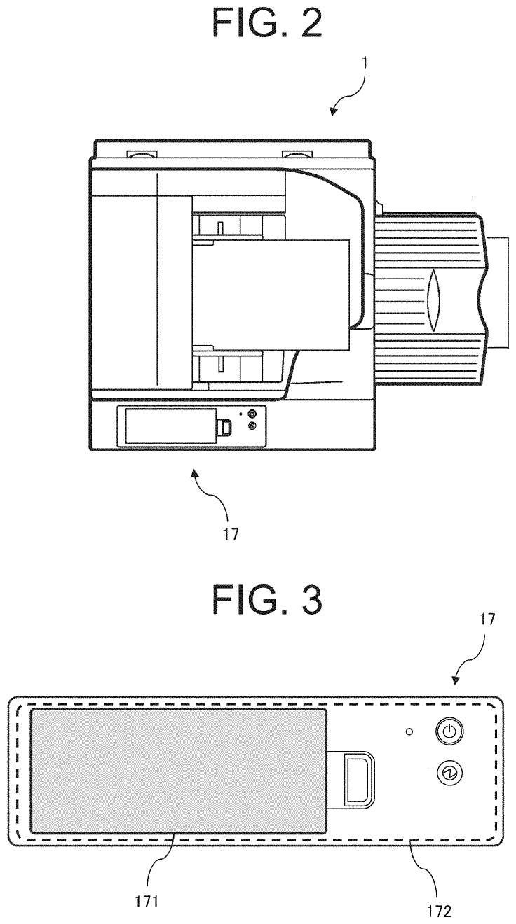

FIG. 2 is a plan view of the digital multifunction printer 1 of FIG. 1. FIG. 3 is an explanatory view of an operation panel 17 of the digital multifunction printer 1 of FIG. 1.

The digital multifunction printer 1 executes a job such as scanning, printing, copying or image transmission in accordance with a command received from a user via the operation panel 17.

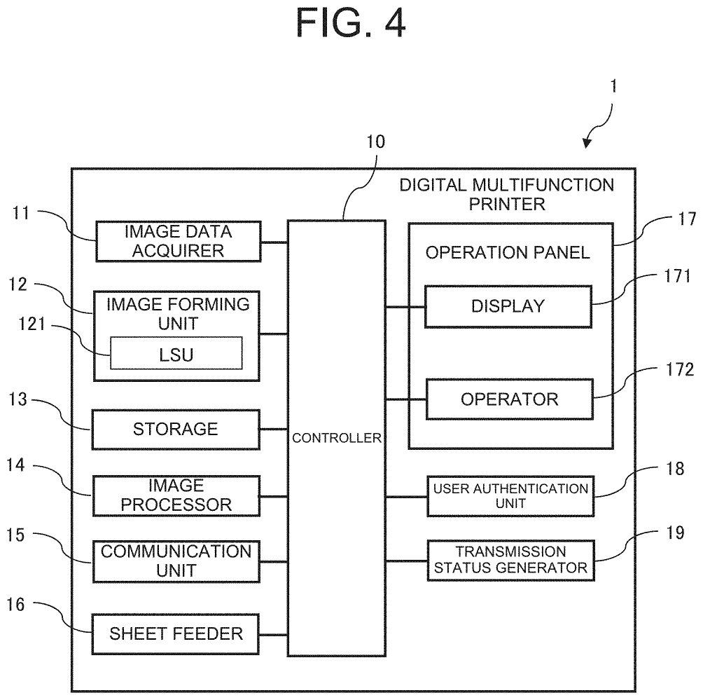

FIG. 4 is a block diagram schematically illustrating a configuration of the digital multifunction printer 1 of FIG. 1.

As illustrated in FIG. 4, the digital multifunction printer 1 includes a controller 10, an image data acquirer 11, an image forming unit 12, a storage 13, an image processor 14, a communication unit 15, a sheet feeder 16, the operation panel 17, a user authentication unit 18, and a transmission status generator 19.

Constituent components of the digital multifunction printer 1 are described below.

The controller 10 integrally controls the digital multifunction printer 1, and includes, for example, a central processing unit (CPU), a random access memory (RAM), a read-only memory (ROM), and various interface circuits.

To control the overall operation of the digital multifunction printer 1, the controller 10 monitors and controls all loads including detections of sensors, a motor, a clutch, the operation panel 17, and the like.

The image data acquirer 11 is a part that detects and reads a document placed on a document table or transported from a document tray, and generates image data.

The image data acquirer 11 may also acquire image data recorded on a universal serial bus (USB) or the like.

The image forming unit 12 is a part that prints out, on a sheet of paper, the image data acquired by the image data acquirer 11 and processed by the image processor 14, and is provided with a laser scanning unit (LSU) 121.

The LSU 121 is a device that forms an electrostatic latent image by irradiating a surface of a photoreceptor drum, which is not shown, when the surface is in a charged state, with a laser beam corresponding to the information of image data formed by digital signals.

The storage 13 is a storage element or medium that stores, for example, information necessary to implement various functions of or a control program for the digital multifunction printer 1. For example, a semiconductor device such as a RAM or a ROM, a storage medium such as a hard disk, a flash storage device, or solid status drive (SSD) is used.

The storage 13 stores information regarding a job, such as a printing job, and data such as image data which is necessary for executing the job.

The storage 13 stores data of the job that has been executed as history information.

The storage 13 also stores information such as the login name and password of the user stored for user authentication.

The program and the data may be held in different devices. For example, the data may be held in a region of the hard disc drive, and the program may be held in a region of the flash storage.

The image processor 14 is a part that converts the image data entered from the image data acquirer 11 into appropriate electrical signals in accordance with the analysis result of a command for the job, such as a printing job obtained through the operator 172, thus processing the image data to suit the output format such as enlargement and reduction.

The communication unit 15 communicates with the external mobile terminal 2 or the like via the network, and transmits and receives various kinds of information, such as a history status of the job or a command for re-transmission, deletion, or the like of the job.

The sheet feeder 16 is a part that conveys a sheet of paper stored in a sheet cassette or a manual sheet feed tray to the image forming unit 12.

The operation panel 17 is formed by a display panel, which is, for example, a liquid crystal panel, and a touch panel such as a capacitive touch panel that is superimposed on the display panel and detects the position where a finger is touched. Thus, the operation panel 17 includes a display 171 and the operator 172.

The display 171 is a part that displays various kinds of information.

The display 171 is formed by, for example, a cathode-ray tube (CRT) display, a liquid crystal display, or an electroluminescence (EL) display, and functions as a display device such as a monitor or a line display for displaying electronic data of, for example, the processing status of the operating system or application software.

The controller 10 displays, on the display 171, the actions and status of the digital multifunction printer 1.

The operator 172 is an interface for operating the digital multifunction printer 1, and a part that receives commands from the user.

The user authentication unit 18 is a part that authenticates the user to determine whether the user is authorized by comparing information such as the login name and password entered from the operator 172 with corresponding information recorded in advance in the storage 13.

The transmission status generator 19 is a part that generates a dedicated page for a job when the user selects and commands execution of the job.

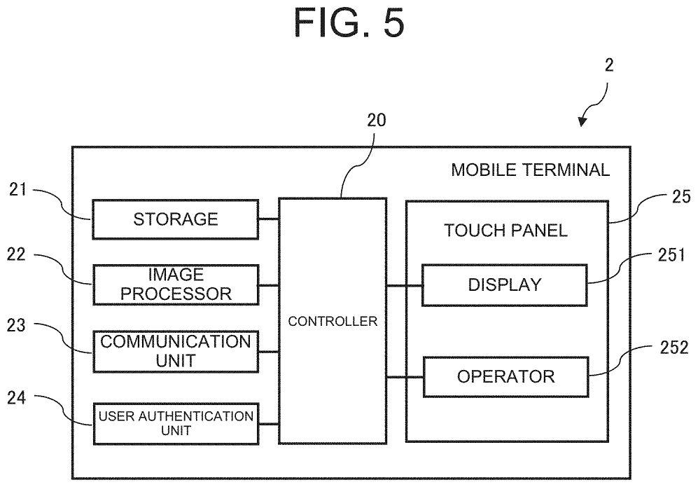

FIG. 5 is a block diagram schematically illustrating a configuration of the mobile terminal 2 of FIG. 1.

As illustrated in FIG. 5, the mobile terminal 2 includes a controller 20, a storage 21, an image processor 22, a communication unit 23, a user authentication unit 24, and a touch panel 25.

The controller 20 integrally controls the mobile terminal 2, and includes, for example, a CPU, a RAM, a ROM, and various interface circuits.

The storage 21 is a storage element or medium that stores, for example, information necessary to implement various functions or a control program of the mobile terminal 2. For example, a semiconductor device such as a RAM or a ROM, a storage medium such as a hard disk, a flash storage device, or solid status drive (SSD) is used.

The image processor 22 is a part that processes an image on the display 251 in accordance with a command from the operator 252, thus processing the image to suit the output format such as enlargement and reduction.

The communication unit 23 communicates with the digital multifunction printer 1 or the like via the network, and transmits and receives various kinds of information, such as a history status of the job or a command for re-transmission, deletion, or the like of the job.

The user authentication unit 24 is a part that authenticates the user to determine whether the user is authorized by comparing information such as the login name and password entered from the operator 252 with corresponding information recorded in advance in the storage 21.

The touch panel 25 is formed by a display panel, which is, for example a liquid crystal panel, and a capacitive touch panel that is superimposed on the display panel and detects the position where a finger is touched. Thus, the touch panel 25 includes a display 251 and the operator 252.

Since the display 251 and the operator 252 have the same configuration as the display 171 and the operator 172, respectively, the description therefor is not repeated.

Example of Job Execution Process of Digital Multifunction Printer 1 of First Embodiment of the Invention

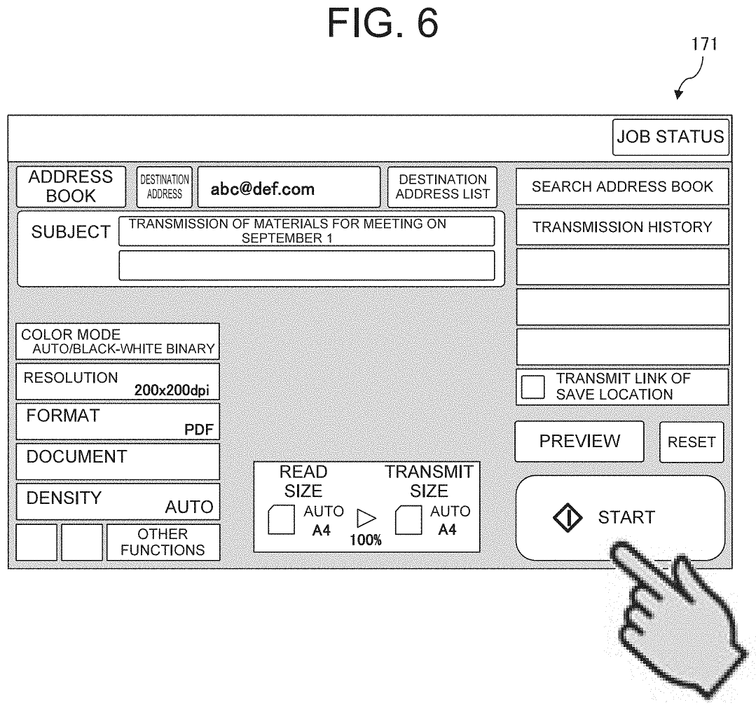

Next, by referring to FIGS. 6 to 8, an example of a job execution process of the digital multifunction printer 1 according to a first embodiment of the present invention is described.

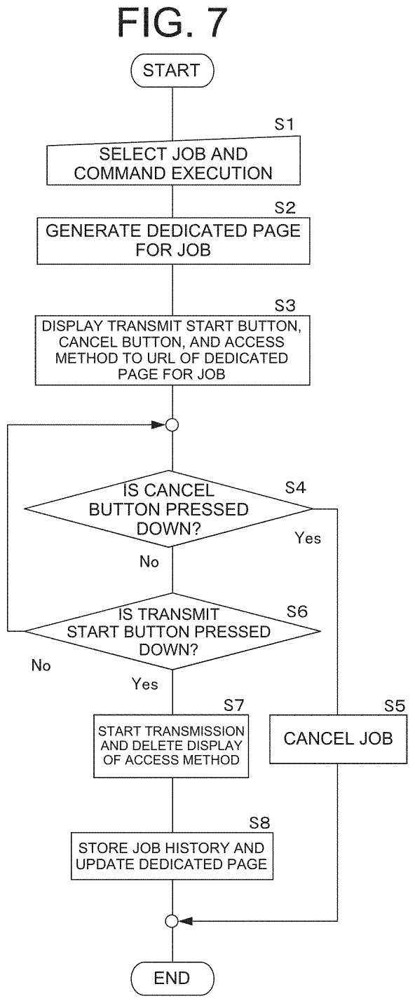

FIG. 6 illustrates an example of a scan mode screen of the digital multifunction printer 1 of FIG. 1. FIG. 7 is a flowchart illustrating a job execution process flow of the digital multifunction printer 1 of FIG. 1.

In the first embodiment, it is assumed that the user transmits scanned data of a document (materials for the meeting on September 1) to a predetermined address (abc@***.com), as illustrated in FIG. 6.

In step S1 of FIG. 7, when the user selects a job and commands execution of the job (step S1), the controller 10 causes, in step S2, the transmission status generator 19 to generate a dedicated page for the job (step S2).

In the example of FIG. 6, the command to execute the job corresponds to pressing of a “Start” key.

Next, in step S3 of FIG. 7, the controller 10 causes the display 171 to display a transmit start button, a cancel button, and a method of accessing a URL of the dedicated page for the job in question (step S3).

Here, the method of accessing the URL of the dedicated page for the job in question includes having the mobile terminal 2 read a QR code of the URL.

Alternatively, the mobile terminal 2 may obtain the URL by short-range wireless communication such as Near Field Communication (NFC) and Bluetooth (registered trademark).

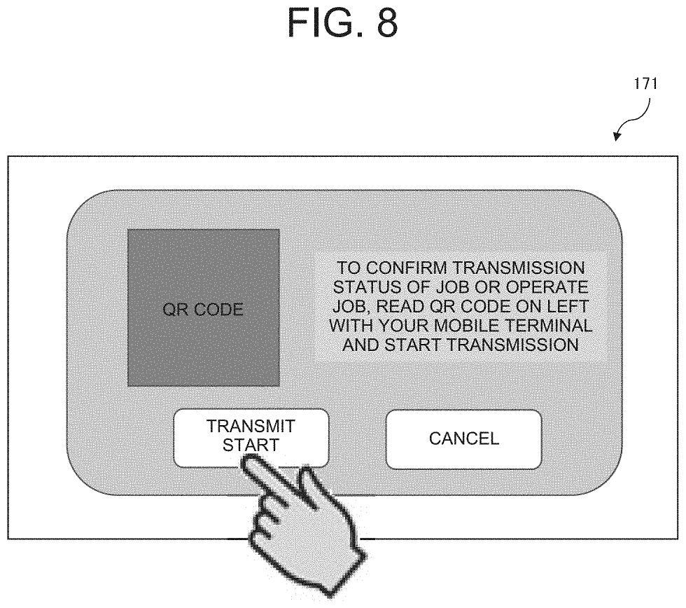

FIG. 8 is an example of a job status transmission dialog of the digital multifunction printer 1 of FIG. 1.

At this time, the job status transmission dialog illustrated in FIG. 8 is displayed on the display 171 after the job is executed.

In the example of FIG. 8, a message: “To confirm the job transmission status or operate the job with your mobile terminal, read the QR code on left and start transmission” is displayed, together with the QR code that enables access the URL of the dedicated page for the job in question.

In addition, the “Transmit start” button and the “Cancel” button are displayed at the bottom of the screen.

When the user reads the QR code with the mobile terminal 2 to display the dedicated page for the job in question on the display 251, and presses the transmit start button, the user can confirm the transmission status of the job on the mobile terminal 2.

When the user presses the transmit start button without having the mobile terminal 2 read the QR code, the job transmission process starts (but the user cannot confirm the job transmission status on the mobile terminal 2).

Next, in step S4 of FIG. 7, the controller 10 determines whether the cancel button is pressed down (step S4).

When the cancel button is pressed down (when the determination of step S4 is Yes), the controller 10 cancels, in step S5, the job in question (step S5).

On the other hand, when the cancel button is not pressed down (when the determination of step S4 is No), the controller 10 determines, in step S6, whether the transmit start button is pressed down (step S6).

When the transmit start button is pressed down (when the determination of step S6 is Yes), the controller 10 starts transmission and deletes the display of the access method in step S7 (step S7).

In a subsequent step S8, the controller 10 stores the history of the job in the storage 13 and causes the transmission status generator 19 to update the dedicated page (step S8).

On the other hand, when the transmit start button is not pressed down (when the determination of step S6 is No), the controller 10 returns the process to step S4 (step S4).

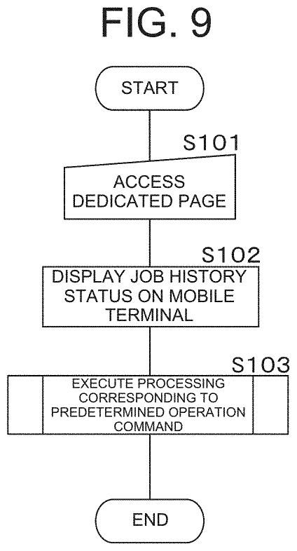

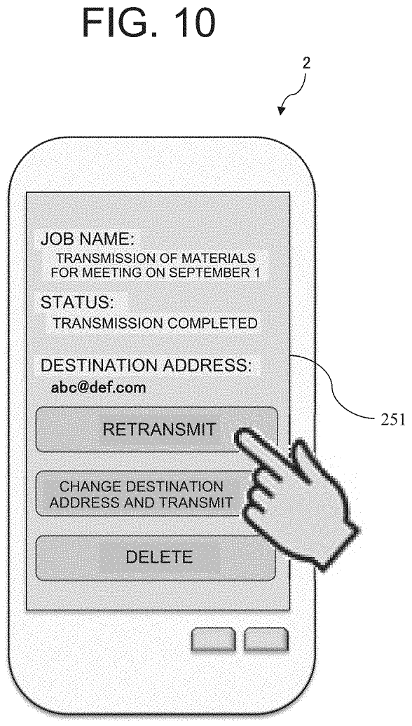

Next, by referring to FIGS. 9 and 10, an example of the access flow to the dedicated page illustrating the transmission status of the job of the digital multifunction printer 1 according to the first embodiment of the present invention is described.

FIG. 9 is a flowchart illustrating an access flow to a dedicated page illustrating the transmission status of the job of the digital multifunction printer 1 of FIG. 1.

In step S101 of FIG. 9, when the user reads the QR code with the mobile terminal 2 and accesses the dedicated page illustrating the job transmission status (step S101), the controller 20 of the mobile terminal 2 causes, in step S102, the display 251 of the mobile terminal 2 to display the history status of the job (step S102).

In a subsequent step S103, the controller 20 performs processing corresponding to a predetermined operation command, such as “Retransmit” or “Change destination address and transmit” (step S103).

FIG. 10 is an example of a screen of the mobile terminal 2 on which a job status screen of the digital multifunction printer 1 of FIG. 1 is displayed.

In the example of FIG. 10, the job name: “Transmission of materials for the meeting on September 1”, the status: “Transmission completed”, and the destination address: abc@def.com” are displayed, under which a “Retransmit” button, a “Change destination address and transmit” button, and a “Delete” button are displayed.

The user can give a desired command by pressing the “Retransmit” button, the “Change destination address and transmit” button, or the “Delete” button.

In this way, the digital multifunction printer 1 in which only the user who has executed the transmission job can refer to and execute the transmission status, even when the user executes the transmission job without user authentication or registration, is provided.

### Second Embodiment

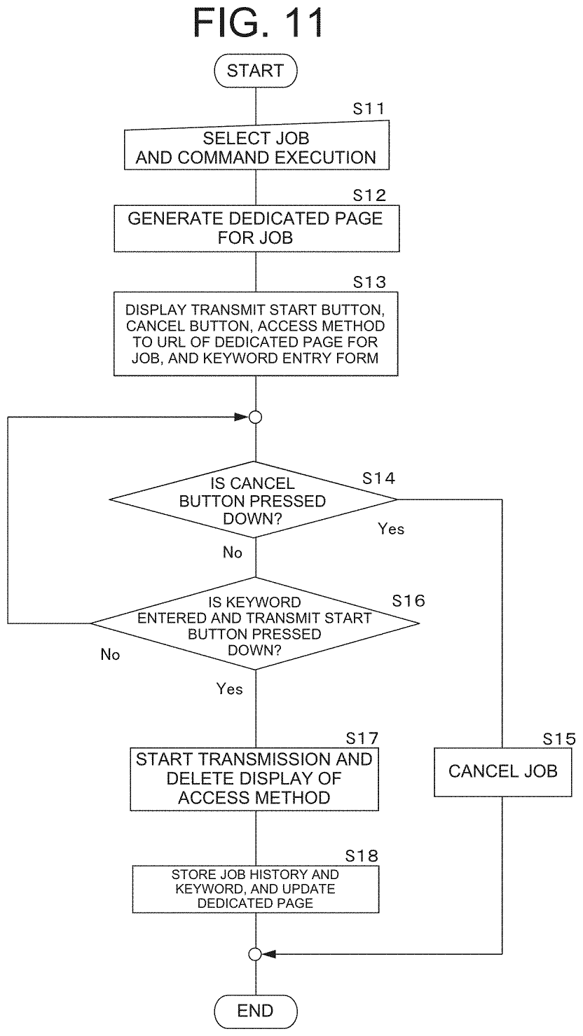

Next, by referring to FIGS. 11 to 15, an example of a job execution process of the digital multifunction printer 1 of a second embodiment of the present invention is described.

Since the schematic configuration of the digital multifunction printer 1 according to the second embodiment is the same as that of FIG. 4 (first embodiment), the description therefor is not repeated.

FIG. 11 is a flowchart illustrating a job execution process flow of the digital multifunction printer 1 according to the second embodiment of the present invention.

Since the processing steps of steps S11, S12, S14, S15 and S17 in FIG. 11 respectively correspond to the processing steps of steps S1, S2, S4, S5 and S7 in FIG. 7 (first embodiment), the description therefor is not repeated.

The processing steps S13, S16 and S18 of FIG. 11, which are not illustrated in FIG. 7, are described herein.

In step S12 of FIG. 11, after the transmission status generator 19 generates the dedicated page for the job in question (step S12), the controller 10 causes the display 171 to display, in step S13, the transmit start button, the cancel button, and the method of accessing the URL of the dedicated page for the job in question, and a keyword entry form (step S13).

Next, in step S14, when the cancel button is not pressed down (when the determination of step S14 is No), the controller 10 determines, in step S16, whether the keyword is entered and the transmit start button is pressed down (step S16).

When the keyword is entered and the transmit start button is pressed down (when the determination of step S16 is Yes), the controller 10, in step S17, starts transmission and deletes the display of the access method (step S17).

On the other hand, when the keyword is entered, but the transmit start button is not pressed down (when the determination of step S16 is No), the controller 10 returns the process to the determination of step S14 (step S14).

In a subsequent step S18, the controller 10 causes the storage 13 to store the job history and the keyword, and causes the transmission status generator 19 to update the dedicated page (step S18).

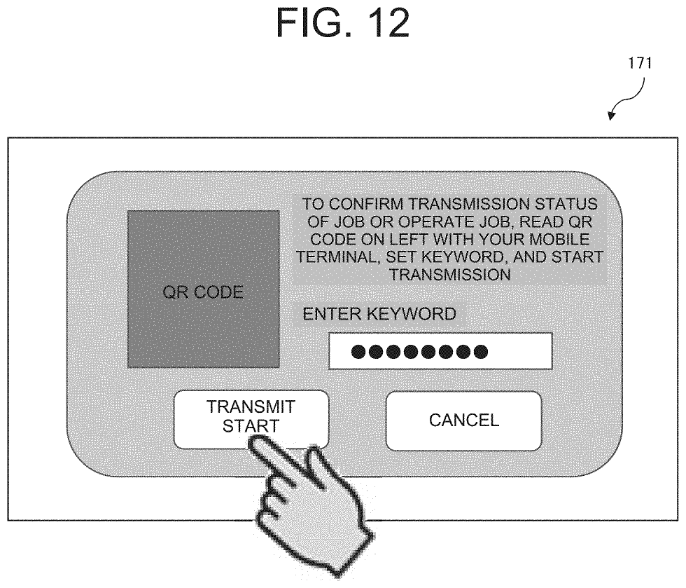

FIG. 12 is an example of a job status transmission dialog of the digital multifunction printer 1 according to the second embodiment of the present invention.

As illustrated in FIG. 12, the job status transmission dialog displayed on the display 171 after the execution of the job also displays a keyword entry form.

When the user reads the QR code with the mobile terminal 2 to display the dedicated page for the job in question on the display 251, enters a keyword, and presses the transmit start button, the user can confirm the transmission status of the job on the mobile terminal 2.

When the user presses the transmit start button without having the mobile terminal 2 read the QR code, the job transmission process starts (but the user cannot confirm the job transmission status on the mobile terminal 2).

As illustrated in FIG. 12, the entered keyword is hidden to prevent the risk of letting the keyword to be known to a third party even when the user leaves the digital multifunction printer 1 in the middle of entering the keyword.

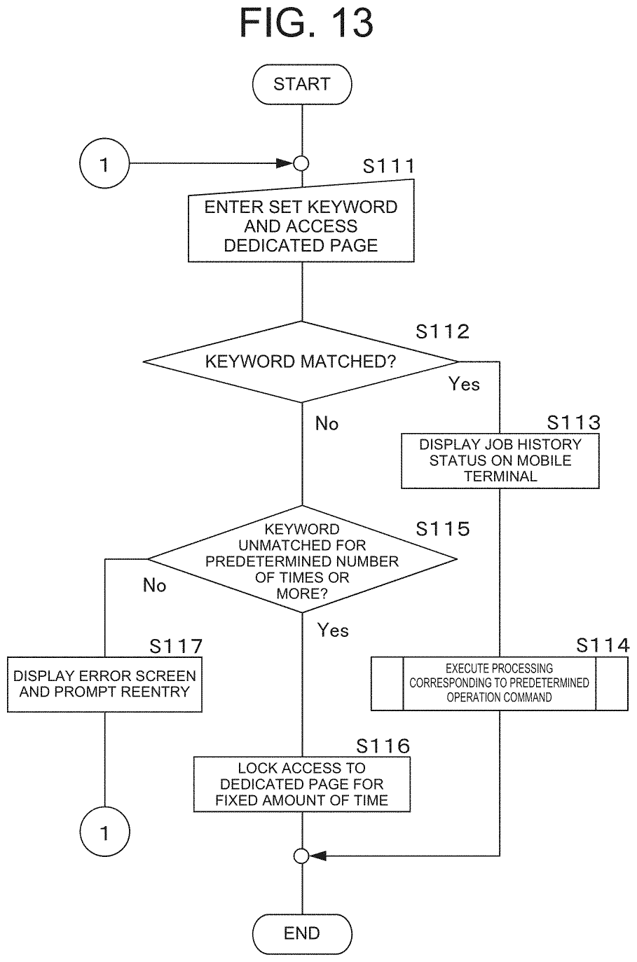

FIG. 13 is a flowchart illustrating an access flow to the dedicated page illustrating the job transmission status of the digital multifunction printer 1 according to the second embodiment of the present invention.

In step S111 of FIG. 13, when the user enters the set keyword on the screen displayed after reading the QR code with the mobile terminal 2, and accesses the dedicated page illustrating the transmission status of the job (step S111), the controller 20 of the mobile terminal 2 determines, in step S112, whether the keyword entered matches the one entered in step S14 of FIG. 11 (step S112).

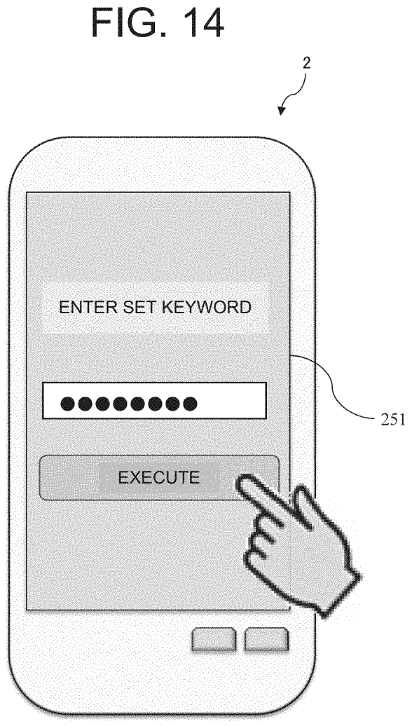

FIG. 14 is an example of the keyword entry screen displayed after the mobile terminal 2 reads the QR code of the job status transmission dialog of the digital multifunction printer 1 according to the second embodiment of the present invention.

As illustrated in FIG. 14, the display 251 of the mobile terminal 2 displays a message: “Enter the set keyword”, together with the keyword entry form and the execute button.

The user enters the set keyword in the keyword entry form and presses the execute button.

When the keyword is matched (when the determination of step S112 is Yes), the controller 20 causes, in step S113, the display 251 of the mobile terminal 2 to display the history status of the job (step S113).

In a subsequent step S114, the controller 20 performs processing corresponding to a predetermined operation command, such as “retransmit” or “change destination address and transmit” (step S114).

On the other hand, when the keyword is unmatched (when the determination of step S112 is No), the controller 20 determines, in step S115, whether the keyword has been unmatched for a predetermined number of times or more (step S115).

When the keyword has been unmatched for the predetermined number of times or more (when the determination of step S115 is Yes), the controller 20 locks, in step S116, access to the dedicated page for a fixed amount of time (step S116).

On the other hand, when the keyword has not been unmatched for the predetermined number of times or more (when the determination of step S115 is No), the controller 20 causes, in step S117, a keyword entry error screen to be displayed to prompt the user to enter the keyword again (step S117).

After that, the controller 20 returns the process to step S111 (step S111).

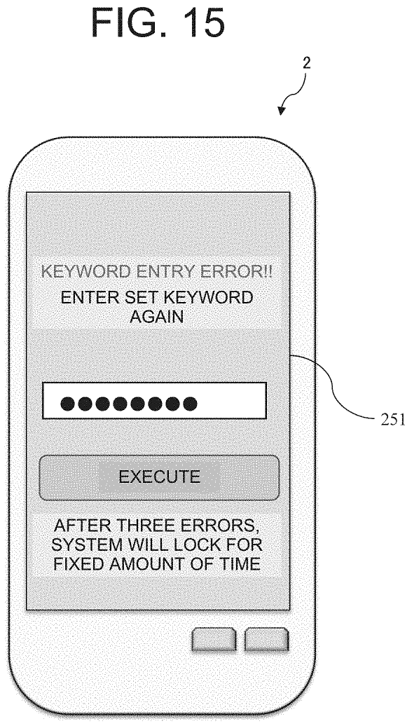

FIG. 15 is an example of the keyword entry error screen of the mobile terminal 2 that accesses the job status screen of the digital multifunction printer 1 according to the second embodiment of the present invention.

As illustrated in FIG. 15, the display 251 of the mobile terminal 2 displays a message: “Keyword entry error!! Enter the set keyword again”, together with the keyword entry form and the execute button.

In addition, a message: “After three errors, the system will lock for a fixed amount of time” is also displayed.

In this way, the job status screen can be accessed only when the keyword entry screen is displayed and the keyword entered matches the one entered before the start of the job transmission. Thus, the digital multifunction printer 1 in which only the user who has executed the transmission job can refer to and execute the transmission status, even when the user executes the transmission job without user authentication or registration, is provided.

In a case where the third party reads the QR code without permission while the user is away from the digital multifunction printer 1 in which the QR code is displayed on the display 171 of the digital multifunction printer 1 before transmitting the job, the third party cannot access the job history information of the user, thus preventing the job history and the leakage of the image data pertaining to the job to the third party.

### Third Embodiment

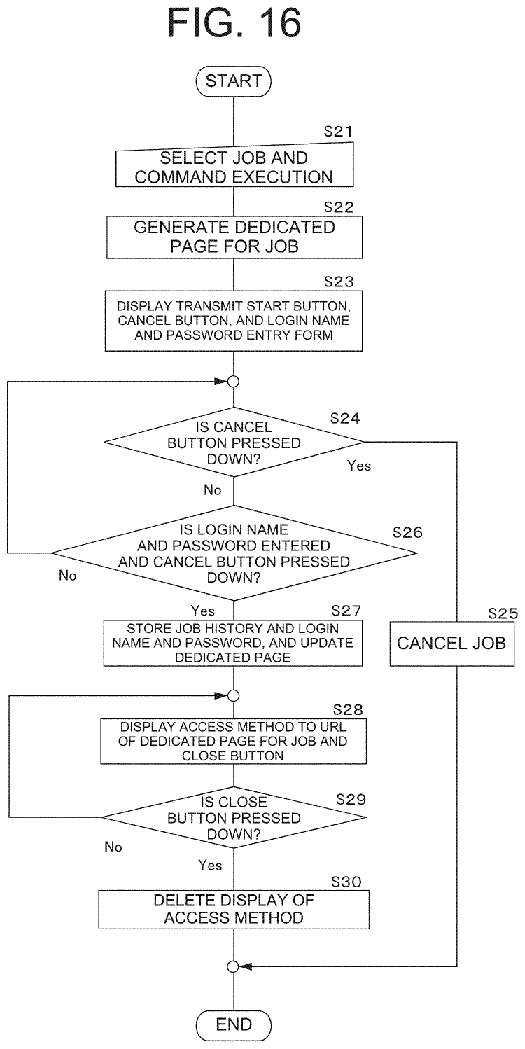

Next, by referring to FIGS. 16 to 20, an example of a job execution process of the digital multifunction printer 1 of a third embodiment of the present invention is described.

Since the schematic configuration of the digital multifunction printer 1 according to the third embodiment is the same as that of FIG. 4 (first embodiment), the description therefor is not repeated.

FIG. 16 is a flowchart illustrating a job execution process flow of the digital multifunction printer 1 according to the third embodiment of the present invention.

Since the processing steps of steps S21, S22, S24, and S25 of FIG. 16 respectively correspond to the processing steps of steps S1, S2, S4, and S5 of FIG. 7 (first embodiment), the description therefor is not repeated.

The processing steps of steps S23 and S26 to S30 of FIG. 16, which are not illustrated in FIG. 7, are described herein.

In step S22 of FIG. 16, after the transmission status generator 19 generates the dedicated page for the job in question (step S22), the controller 10 displays, in step S23, the transmit start button, the cancel button, and the login name and password entry form on the display 171 (step S23).

Next, in step S24, when the cancel button is not pressed down (when the determination of step S24 is No), the controller 10 determines, in step S26, whether the entry of the login name and the password is made and whether the transmit start button is pressed down (step S26).

When the entry of the login name and the password is made and the transmit start button is pressed down (when the determination of step S26 is Yes), the controller 10 causes, in step S27, the storage 13 to store the job history and the login name and password, and causes the transmission status generator 19 to update the dedicated page (step S27).

On the other hand, when the entry of the login name and the password is made and the transmit start button is not pressed down, or when at least one of the login name and the password is unentered and the transmit start button is not pressed down (when the determination of step S26 is No), the controller 10 returns the process to the determination in step S24 (step S24).

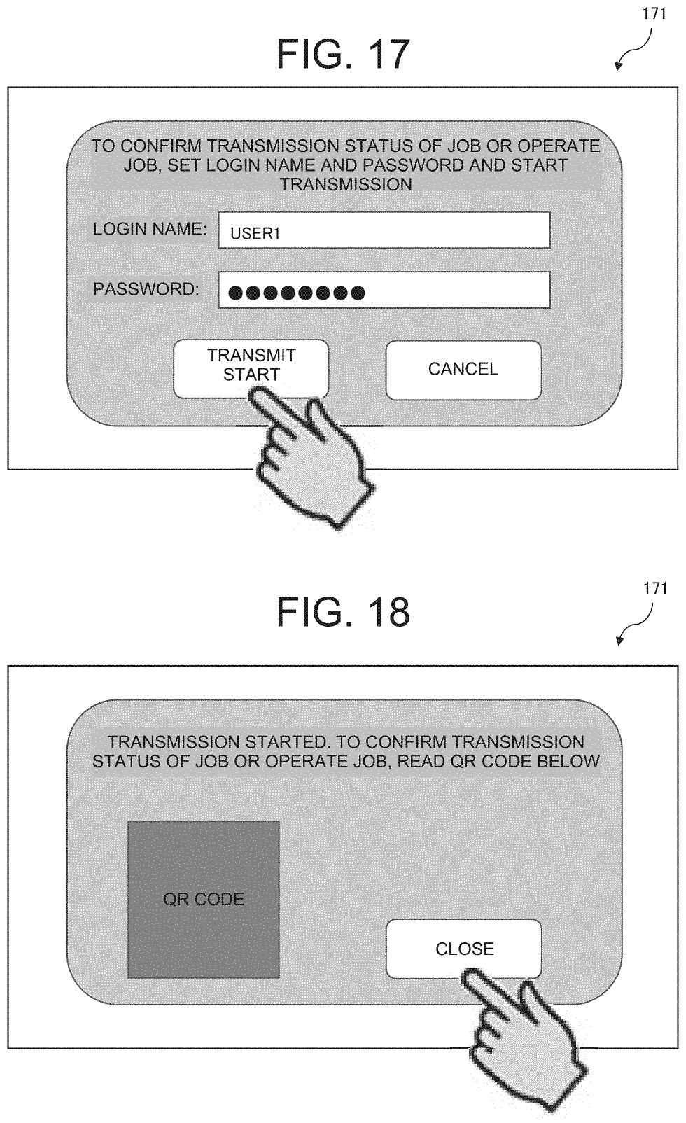

FIG. 17 is an example of a job status transmission dialog of the digital multifunction printer 1 according to the third embodiment of the present invention.

As illustrated in FIG. 17, the job status transmission dialog displayed on the display 171 after the execution of the job includes the message: “To confirm the transmission status of the job or operate the job, set the login name and password and start transmission”, together with the login name and password entry form.

The user enters a login name and password and presses the transmit start button.

The login name and password to be entered may be temporarily created on an ad hoc basis.

Next, in step S28 of FIG. 16, the controller 10 causes the display 171 to display the method of accessing the URL of the dedicated page for the job and the “Close” button (step S28).

FIG. 18 is an example of a dialog illustrating a method of accessing the URL of the dedicated page for the job of the digital multifunction printer 1 according to the third embodiment of the present invention.

In the example of FIG. 18, the message: “Transmission started. To confirm the transmission status of the job or operate the job, read the QR code below” is displayed, together with the QR code that enables access to the URL of the dedicated page for the job.

At the bottom of the screen, the “Close” button is also displayed.

Next, in step S29 of FIG. 16, the controller 10 determines whether the close button is pressed down (step S29).

When the close button is pressed down (when the determination of step S29 is Yes), the controller 10 deletes the display of the access method in step S30 (step S30).

On the other hand, when the close button is not pressed down (when the determination of step S29 is No), the controller 10 returns the process to step S28 (step S28).

In a case where the cancel button is pressed down in step S24, the job is cancelled, and the dialog (FIG. 18) illustrating how to access the URL of the dedicated page for the job is not displayed.

As a modification, even when the user does not press down the close button, the display of the access method may be deleted when a predetermined amount of time has passed or when a motion sensor is provided to detect that the user has left the digital multifunction printer 1.

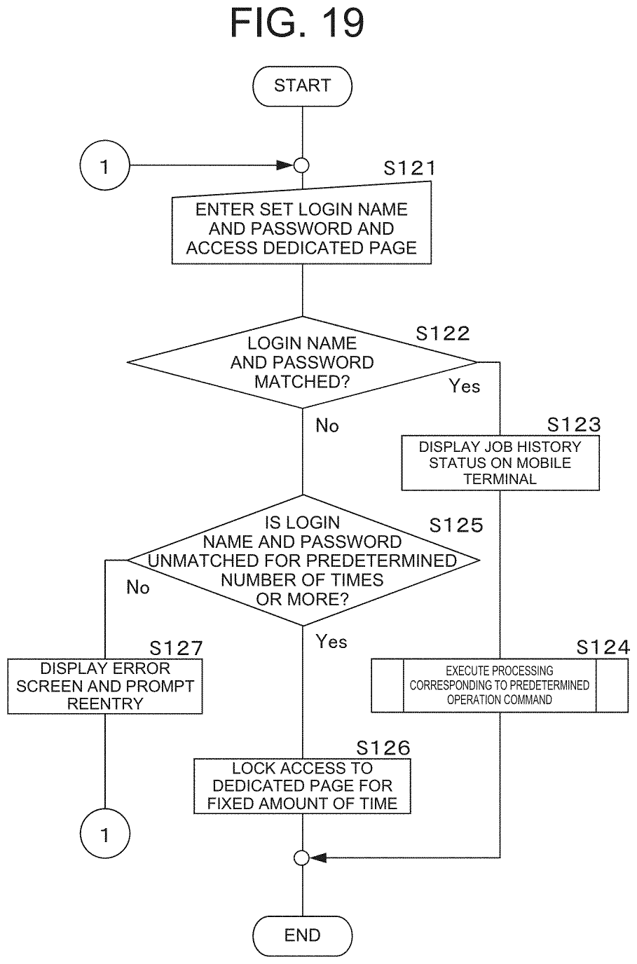

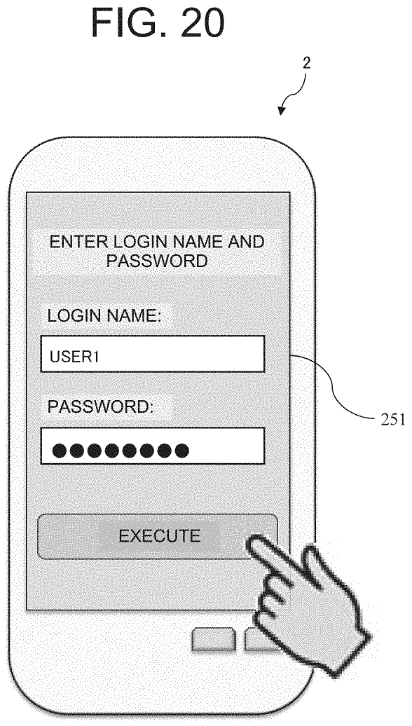

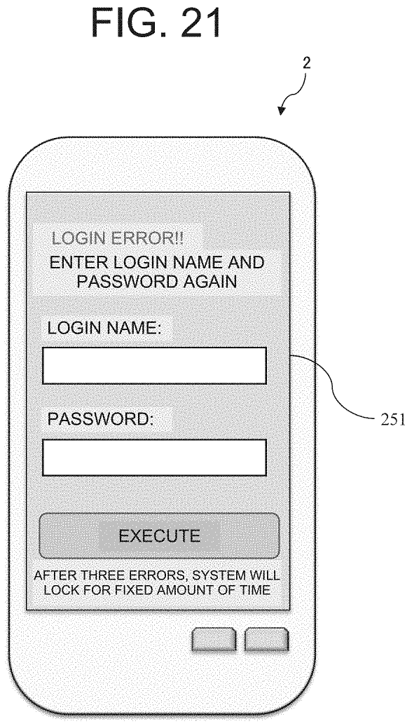

FIG. 19 is a flowchart illustrating an access flow to the dedicated page illustrating the job transmission status of the digital multifunction printer 1 according to the third embodiment of the present invention. FIG. 20 is an example of the login name and password entry screen displayed after the mobile terminal 2 reads the QR code (registered trademark) of the job status transmission dialog of the digital multifunction printer 1 according to the third embodiment of the present invention. FIG. 21 is an example of a login name and password entry error screen of the mobile terminal 2 that accesses the job status screen of the digital multifunction printer 1 according to the third embodiment of the present invention.

In the third embodiment, the procedure for accessing the dedicated page illustrating the transmission status of the job of the digital multifunction printer 1 is the same as the procedure of the second embodiment, except for the entry of the login name and the password instead of the keyword, so that the description therefor is not repeated.

In this way, the job status screen can be accessed only when the login name and password matches the one entered before the start of job transmission. Thus, the digital multifunction printer 1 in which only the user who has executed the transmission job can refer to and execute the transmission status, even when the user executes the transmission job without user authentication or registration, is provided.

In a case where the QR code is displayed, after the job transmission, on the display 171 of the digital multifunction printer 1, and the third party reads the QR code without permission, the third party cannot access the job history information of the user, thus preventing the leakage of the job history and the image data pertaining to the job in question to the third party.

Furthermore, entering the disposable and temporary login name and password created ad hoc can achieve a higher level of security compared to the case of simply entering keywords.

### Fourth Embodiment

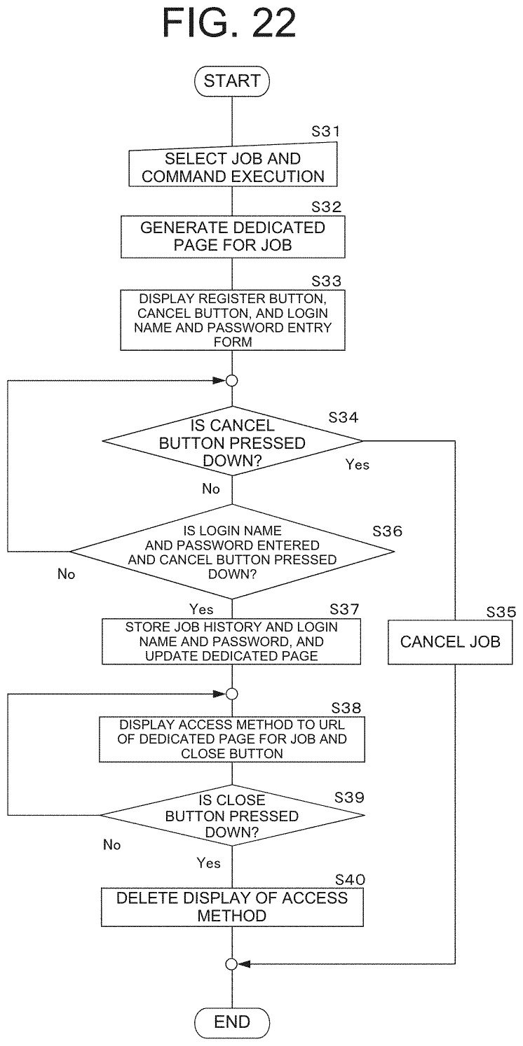

Next, by referring to FIGS. 22 to 29, an example of a job execution process of the digital multifunction printer 1 of a fourth embodiment of the present invention is described.

Since the schematic configuration of the digital multifunction printer 1 according to the fourth embodiment is the same as that of FIG. 4 (first embodiment), the description therefor is not repeated.

FIG. 22 is a flowchart illustrating a job execution process flow of the digital multifunction printer 1 according to the fourth embodiment of the present invention.

Since the processing steps of steps S31, S32, S34, and S35 of FIG. 22 respectively correspond to the processing steps of steps S1, S2, S4, and S5 of FIG. 7 (first embodiment), the description therefor is not repeated.

The processing steps of steps S33 and S36 to S40 of FIG. 22, which are not illustrated in FIG. 7, are described herein.

In step S32 of FIG. 22, after the transmission status generator 19 generates the dedicated page for the job in question (step S32), the controller 10 causes, in step S33, the display 171 to display a register button, a cancel button, and a login name and password entry form (step S33).

Next, in step S34, when the cancel button is not pressed down (when the determination of step S34 is No), the controller 10 determines, in step S36, whether the entry of the login name and password is made, and the register button is pressed down (step S36).

When the entry of the login name and password is made and the register button is pressed down (when the determination of step S36 is Yes), the controller 10 causes, in step S37, the storage 13 to store the job history and the login name and password, and causes the transmission status generator 19 to update the dedicated page (step S37).

On the other hand, when the entry of the login name and the password is made but the register button is not pressed down (when the determination of step S36 is No), the controller 10 returns the process to the determination of step S34 (step S34).

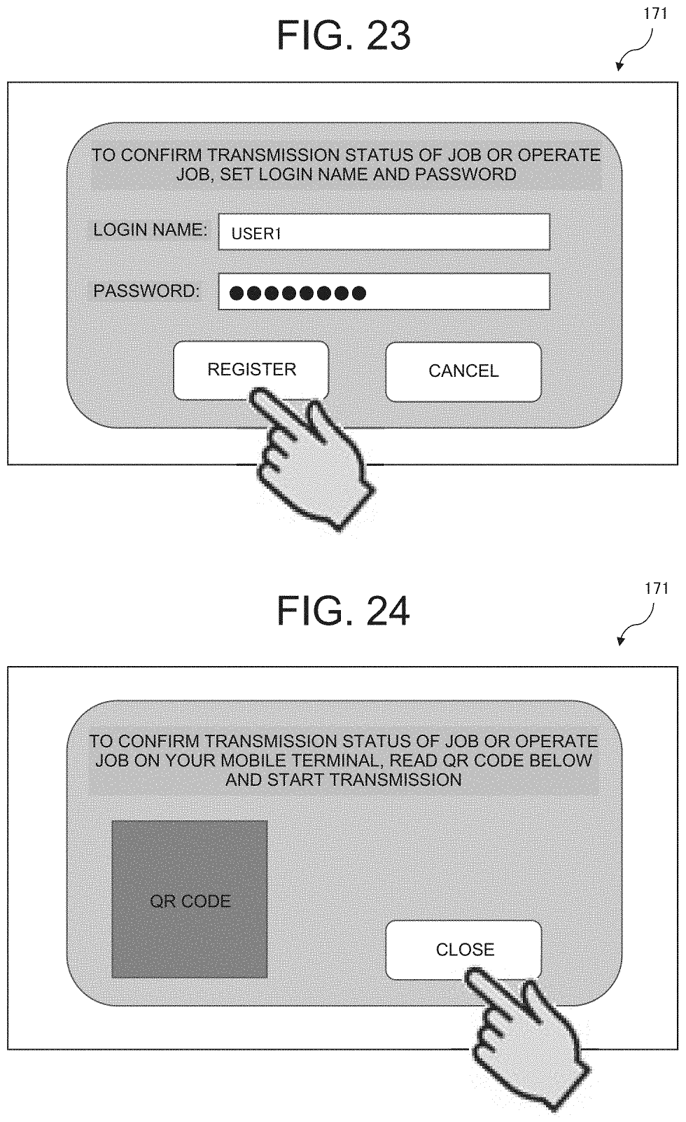

FIG. 23 is an example of a login name and password registration dialog of the digital multifunction printer 1 according to the fourth embodiment of the present invention.

In the example illustrated in FIG. 23, the display 171 displays the message: “To confirm the job transmission status or operate the job, set the login name and password”, together with the login name and password entry form.

Note that, in the fourth embodiment, the register button is displayed instead of the transmit start button.

The user enters arbitrary login name and password, and presses the register button.

The login name and password to be entered may be temporarily created on an ad hoc basis.

Next, in step S38 of FIG. 22, the controller 10 causes the display 171 to display the method of accessing the URL of the dedicated page for the job in question and the “Close” button (step S38).

FIG. 24 is an example of a dialog illustrating a method of accessing the URL of the dedicated page for the job of the digital multifunction printer 1 according to the fourth embodiment of the present invention.

In the example of FIG. 24, the message: “To confirm the job transmission status or operate the job on your mobile terminal, read the QR code below and start transmission” is displayed, together with the QR code that enables access to the URL of the dedicated page of the job in question.

At the bottom of the screen, the “Close” button is also displayed.

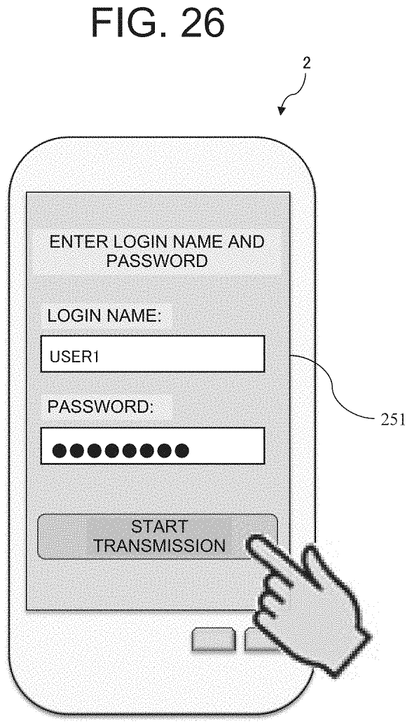

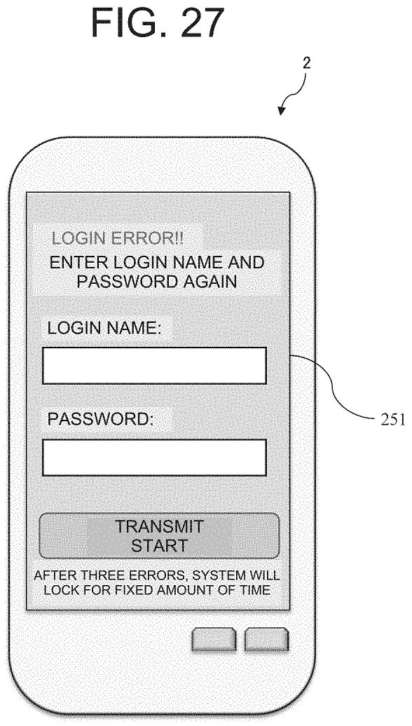

In this case, the “Transmit start” button may be displayed in FIG. 24, and if so, the “Transmit start” button is not displayed in FIGS. 26 and 27.

In FIG. 24, when the user reads the QR code with the mobile terminal 2 to display the dedicated page for the job in question on the display 251, and presses the transmit start button, the user can confirm the transmission status of the job on the mobile terminal 2.

When the user presses the transmit start button in FIG. 24 without having the mobile terminal 2 read the QR code, the job transmission process starts (the user cannot confirm the job transmission status on the mobile terminal 2).

Next, in step S39 of FIG. 22, the controller 10 determines whether the close button is pressed down (step S39).

When the close button is pressed down (when the determination of step S39 is Yes), the controller 10 deletes the display of the access method in step S40 (step S40).

On the other hand, when the close button is not pressed down (when the determination of step S39 is No), the controller 10 returns the process to step S38 (step S38).

In a case where the cancel button is pressed down in step S34, the job is cancelled, and if so, the dialog (FIG. 24) illustrating the access method to the URL of the dedicated page for the job is not displayed.

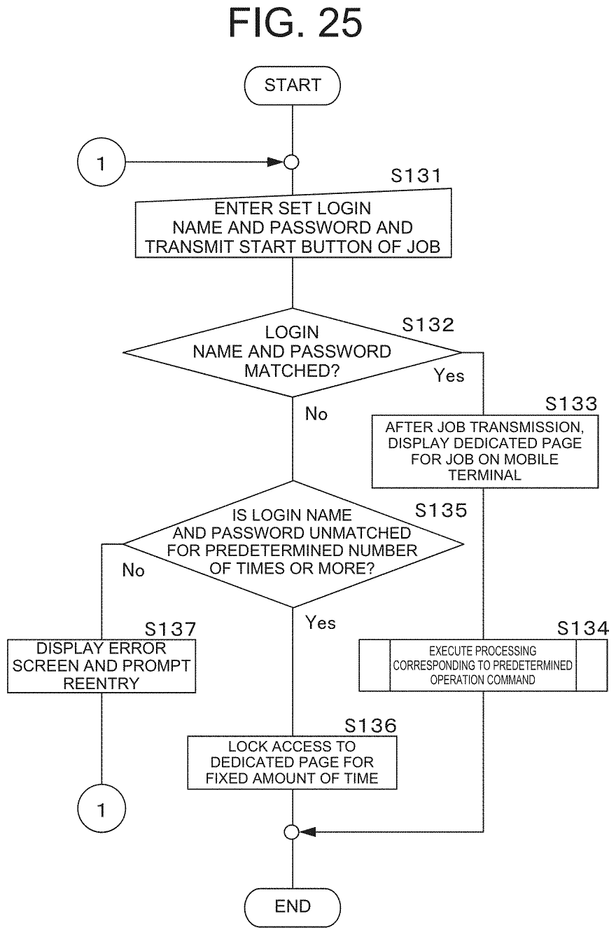

FIG. 25 is a flowchart illustrating an access flow to the dedicated page illustrating the job transmission status of the digital multifunction printer 1 according to the fourth embodiment of the present invention.

Since the processing steps of steps S134 to S137 in FIG. 25 respectively correspond to the processing steps of steps S124 to S127 in FIG. 19 (third embodiment), the description therefor is not repeated.

The processing steps of steps S131 to S133 of FIG. 25, which are not illustrated in FIG. 19, are described herein.

In step S131 of FIG. 25, when the user enters the login name and password and the transmit start button of the job on the screen displayed after reading the QR code with the mobile terminal 2 (step S131), the controller 20 of the mobile terminal 2 determines, in step S132, whether the entered login name and password matches the one entered in step S34 of FIG. 22 (step S132).

When the login name and password is matched (when the determination of step S132 is Yes), the controller 20 communicates, in step S133, with the digital multifunction printer 1 to transmit the job, and causes the display 251 of the mobile terminal 2 to display the dedicated page for the job in question (step S133).

FIG. 26 is an example of the login name and password entry screen displayed after the mobile terminal 2 reads the QR code of the job status transmission dialog of the digital multifunction printer 1 according to the fourth embodiment of the present invention.

As illustrated in the example in FIG. 26, the transmit start button is displayed below the login name and password entry form.

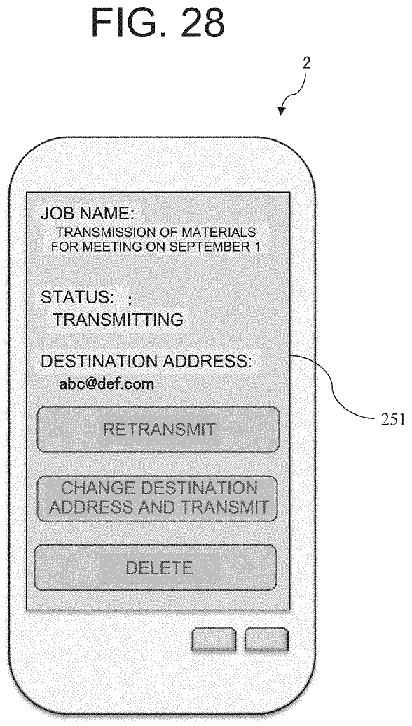

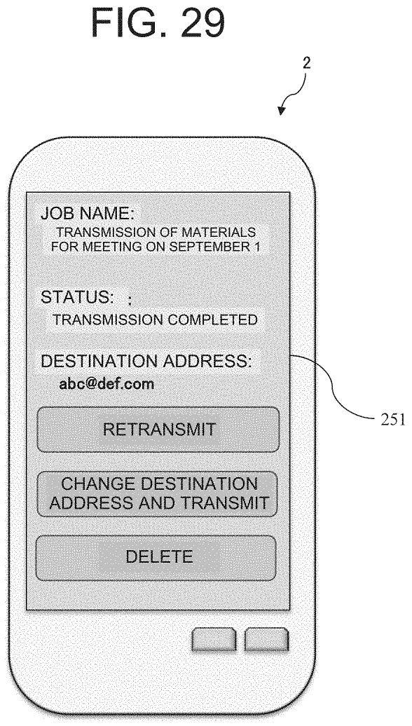

FIG. 27 is an example of the login name and password entry error screen of the mobile terminal 2 that accesses the job status screen of the digital multifunction printer 1 according to the fourth embodiment of the present invention. FIG. 28 is an example of a screen of the mobile terminal 2 on which the job transmission status is displayed as the job status screen of the digital multifunction printer 1 according to the fourth embodiment of the present invention, and is also an example of a screen displayed between the time when the transmit start button is pressed down in FIG. 26 and the job transmission is completed. FIG. 29 is an example of a screen of the mobile terminal 2 on which the transmission completed status of the job is displayed as the job status screen of the digital multifunction printer 1 according to the fourth embodiment of the present invention.

When the error screen is displayed in step S137 of FIG. 25 (step S137), the controller 10 of the digital multifunction printer 1 may alert the user by causing the display 171 to display a message saying that the transmission of the job has been stopped because of unauthorized access and that the user should be careful not to have the QR code read by the third party.

In this way, the job status screen is displayed only when the login name and password matches the one registered before the start of job transmission. Thus, the digital multifunction printer 1 in which only the user who has executed the transmission job can refer to the transmission status, even when the user executes the transmission job without user authentication or registration, is provided.

Preferred embodiments of the present invention also include a combination of any of the above-described embodiments.

Various modifications of the present invention may be made in addition to the above-described embodiments. Such modifications shall not be construed as departing from the scope of the present invention. The present invention shall cover all equivalents of the appended claims and all modifications falling within the scope of the appended claims

What is claimed is:

1. An image data transmission apparatus, comprising:
an operator that receives a command from a user;
a transmission status generator that generates a dedicated page to check a transmission status of image data;
a display that displays various kinds of screens; and
a controller that controls the operator, the transmission status generator, and the display, wherein
when the operator receives a command to transmit the image data, the controller causes the transmission status generator to generate the dedicated page to check the transmission status of the image data, and causes the display to display a transmission screen including address information that enables access to the dedicated page, and a transmit start button to start transmission of the image data.

2. The image data transmission apparatus according to claim 1, wherein
when the operator receives the command to start transmission of the image data, the controller hides the address information on the display.

3. The image data transmission apparatus according to claim 1, wherein
the controller causes the display to display the transmission screen in a code format allowing a mobile terminal to read the address information that enables access to the dedicated page.

4. The image data transmission apparatus according to claim 1, wherein
the controller causes the display to display the transmission screen including an authentication information entry form for setting authentication information to allow access to the dedicated page.

5. The image data transmission apparatus according to claim 1, wherein
the controller causes the transmission status generator to generate the dedicated page on which at least one of a button for retransmitting the image data, a button for changing a destination address of the image data for transmission, and a button for deleting the image data is displayed.

6. An image data transmission apparatus, comprising:
an operator that receives a command from a user;
a transmission status generator that generates a dedicated page to check a transmission status of image data;
a display that displays various kinds of screens; and
a controller that controls the operator, the transmission status generator, and the display, wherein
when the operator receives a command to transmit the image data, the controller causes the transmission status generator to generate the dedicated page to check the transmission status of the image data, and causes the display to display a registration screen including an authentication information entry form for registering authentication information to access the dedicated page.

7. The image data transmission apparatus according to claim 6, wherein
when the operator accepts registration of the authentication information, the controller causes the display to display address information that enables access to the dedicated page.

8. The image data transmission apparatus according to claim 1, wherein
when a predetermined amount of time has passed after the controller causes the display to display the address information, the controller hides the address information on the display.

9. The image data transmission apparatus according to claim 6, wherein
when a predetermined amount of time has passed after the controller causes the display to display the address information, the controller hides the address information on the display.

10. An image data transmission method, comprising:
operating to receive a command from a user;
generating a transmission status to generate a dedicated page to check a transmission status of image data; and
displaying various kinds of screens; wherein
when a command to transmit the image data is received in the operating, the dedicated page to check the transmission status of the image data is generated in the generating of the transmission status, and in the displaying, a transmission screen including address information that enables access to the dedicated page and a transmit start button to start transmission of the image data is displayed.

11. An image data transmission method, comprising:
operating to receive a command from a user;
generating a transmission status to generate a dedicated page to check a transmission status of image data; and
displaying various kinds of screens; wherein
when a command to transmit the image data is received in the operating, the dedicated page to check the transmission status of the image data is generated in the generating of the transmission status, and in the displaying, a registration screen including an authentication information entry form for registering authentication information to allow access to the dedicated page is displayed.
